(19) United States
(12) Patent Application Publication
(10) Pub. No.: US 2003/0027540 A1
(43) Pub. Date: Feb. 6, 2003

(54) Diversity combiner and associated methods

(76) Inventor: Serge Barbosa Da Torre, Saint Raphael (FR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/920,336

(22) Filed: Jul. 31, 2001

(51) Int. Cl. H04B 1/06

(52) U.S. Cl. 455/277.1; 455/278.1; 455/562

(57) ABSTRACT

A diversity combiner and associated methods are introduced. According to one example implementation, an apparatus comprising a multi-antenna combiner and a combiner controller is presented, wherein the multi-antenna combiner selectively modifies each of two or more received wireless communication signals to generate a composite signal from at least a subset of the modified received signals. The combiner controller, coupled to the multi-antenna combiner, dynamically generates control parameters associated with each of the received signals to control combiner modification of the signals in generating the composite signal based, at least in part, on one or more quality values generated during baseband processing of previous composite signal(s).

### TECHNICAL FIELD

This invention generally relates to wireless communication systems and, more particularly, to a diversity combiner and associated methods for receiving and processing wireless communication signals.

### BACKGROUND

Wireless communication systems are not new. Indeed, two-way radio technology dates back to the beginning of the 20^{th} century, while its progeny, cellular telephony systems, were first introduced in the early 70's. In such wireless communication systems, a basestation communicates with multiple mobile devices in wireless fashion. As the technology developed and the cost associated with owning and using a cellular telephone decreased, the popularity of the wireless telephony systems exploded. To accommodate this growth in the subscriber base, digital cellular techniques were developed and standardized to increase user capacity of the cellular system without a commensurate increase in the radio frequency (RF) power generated within the system.

A number of different digital wireless communication technologies have been introduced and provide the basis for a number of wireless communication system architectures. Two primary examples of digital wireless technology are the time-division multiple access (TDMA) and code-division multiple access (CDMA) technologies. In a TDMA system, a carrier frequency is parsed into independent incremental units of time, referred to as a timeslot, wherein each timeslot at a carrier frequency supports an independent communication session between a subscriber unit (or, handset) and a communication station (or, base station). That is, while a communication channel in a conventional analog communication system is commonly defined by its carrier frequency (i.e., a frequency division multiple access (FDMA) system), a communication channel in a TDMA system is defined by a timeslot on a particular carrier frequency. Carving a given carrier frequency into N-independent timeslots results in an N-fold increase in system capacity over traditional FDMA system, with only a nominal increase in radiated power. In practice, an increase in capacity of two- to eight-fold has been achieved.

In a CDMA system, a communication channel is defined by a pseudo-noise (PN) code contained in the header of digital communication packets passed between the subscriber unit and the communication station. To further enhance system capacity, the CDMA system is a spread-spectrum system wherein the communication channel (defined by the PN code) hops through any of a number of carrier frequencies over an assigned band of radio frequency (or higher) spectrum.

While the introduction of such digital cellular techniques have certainly increased system capacity, developers of wireless communication system equipment continue to introduce enhancements designed to increase capacity and improve system performance without increasing the radio frequency (RF) power in the system, often measured in terms of a wireless link budget. An example of such a development is the use of antenna arrays and, more particularly, the development and implementation of smart antenna technology. Antenna arrays introduce what is commonly referred to as spatial diversity, wherein each antenna in the array effectively provides a signal that is not completely correlated with the signals provided by other antenna in the array. These decorrelated (i.e., not fully correlated, as opposed to [completely] uncorrelated) signals provide a receiver with a number of alternative signals, each a decorrelated representation of the transmitted signal, from which an estimate of the originally transmitted signal is can be generated.

The techniques for utilizing such decorrelated signals in a receiver to generate an estimate of the originally transmitted signal can be generally classified into several categories: signal selection, signal combining, selection and combining, and other techniques, each having their respective advantages and disadvantages. In receivers that rely on such signal selection, for example, only one of the multiple received signals is selected. The selection can happen before RF downconversion to baseband (colloquially referred to as pre-selection) or at the baseband processing stage (post-selection).

An advantage to pre-selection is that only one radio (e.g., filters, amplifier, downconverter, etc.) is required to reduce the selected signal to baseband. The disadvantage being that the selection of one of the plurality of received signals is typically based on limited information (e.g., received signal strength indication (RSSI)). On the other hand, while post-selection techniques utilize more refined quality parameters (e.g., signal to interference and noise ratio (SINR), cyclical redundancy check (CRC) error control, and the like) to select the best signal, they require that all of the received signals be downconverted to baseband and, thus, require multiple receiver radios (amplifiers, filters, downconverters, etc.) and are expensive to implement.

Conventional combining techniques attempt to utilize energy from all of the received signals by combining them in some fashion. As with the pre- and post-selection techniques introduced above, one can perform pre-combining or post-combining. In pre-combining, one needs to perform the combining at the RF stage, typically utilizing a delay and sum approach, where each of the signals are summed together. Those skilled in the art will appreciate that this is equivalent to performing a phase shift of the various RX signals before summing. This is typically performed to form “beams”, where each beam represents a geometrical angle direction of the antenna array. Each beam signal is further downconverted to baseband through its own radio.

Such combining techniques are highly complex to implement in hardware, especially when one needs to consider the hardware calibration issues and the fact that the beam forming needs a geometric characterization of the antenna array. It is also not well suited to mobile devices, as the channel characterization at the mobile side does not follow such geometric beam considerations.

Thus, an improved diversity combiner and associated methods are required, unencumbered by the deficiencies and limitations commonly associated with the prior art.

Just such a solution is presented below.

### SUMMARY

A diversity combiner and associated methods are introduced. According to one example implementation, an apparatus comprising a multi-antenna combiner and a combiner controller is presented, wherein the multi-antenna combiner selectively modifies each of two or more received wireless communication signals to generate a composite signal from at least a subset of the modified received signals. The combiner controller, coupled to the multi-antenna combiner, dynamically generates control parameters associated with each of the received signals to control combiner modification of the signals in generating the composite signal based, at least in part, on one or more quality values generated during baseband processing of previous composite signal(s).

### BRIEF DESCRIPTION OF THE DRAWINGS

The present invention is illustrated by way of example, and not necessarily by way of limitation in the figures of the accompanying drawings in which like reference numerals refer to similar elements.

FIG. 1 is a block diagram of an example wireless communication system within which the teachings of the present invention may well be practiced;

FIG. 2 is a block diagram of an example receiver incorporating an innovative diversity combiner module, according to one embodiment of the present invention;

FIG. 3 is a block diagram of an example diversity combiner module, according to one embodiment of the present invention;

FIG. 4 is a graphical illustration of an example data structure within utilized by the diversity combiner, according to one example implementation of the present invention;

FIG. 5 is a flow chart of an example method for performing pre-combining in accordance with the teachings of the present invention; and

FIG. 6 illustrates an example storage medium comprising a plurality of executable instructions which, when executed by a processing device, implements the teachings of the present invention, in accordance with another embodiment of the present invention.

### DETAILED DESCRIPTION

This invention concerns a diversity combiner and associated methods for selectively combining received wireless communication signals. According to one aspect of the present invention, a diversity combiner module is introduced comprising a diversity combiner selectively controlled by a combiner control agent. As will be developed more fully below, the diversity combiner modifies one or more aspects of the received signals in accordance with one or more modification parameters received from the control agent, before the modified signals are summed and presented to a single receive radio for downconversion and baseband processing. Unlike conventional combining techniques, however, the control agent accepts quality information from one or more baseband processors before generating the modification parameters supplied to the diversity combiner. In this regard, the innovative diversity combiner module incorporates the best elements of each of the pre- and post-combiner techniques to implement a receiver that requires only one receive radio, while applying more than simplistic RF metrics to the combining of such RF signals.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

### Example Communication System

FIG. 1 illustrates an example communication system including a wireless communication system within which the teachings of the present invention may be practiced. As shown in FIG. 1, wireless communication system 102 is coupled to a wireline communication network 104. Wireless communication system 102 is depicted comprising one or more wireless handset(s) (or, subscriber units) 106, 108 communicatively coupled to one or more communication stations (or, base stations) 114 via wireless communication links 110, 112.

As shown, handsets 106, 108 may engage in a communication session with one another, or with other handset(s) (not shown) via one or more communicatively coupled communication station(s) (e.g., 114) through such wireless communication links. Similarly, handsets 106, 108 may engage in a communication session with one or more wireline telephones 118, 120 via a wireless communication link (110, 112) established through an appropriate communication station (e.g., 114) coupled to the wireline network 104. Although not specifically depicted, those skilled in the art will appreciate that wireless network 102 may well be communicatively coupled to other wireless communication systems, e.g., through a wireless communication system switching network (not shown), through a wireline network 104, etc. In accordance with one example implementation, wireless communication system 102 is intended to represent a time-division multiple access (TDMA), time division duplex (TDD) communication system. It is to be appreciated, however, that the teachings of the present invention may well be readily adapted to other types of wireless communication systems such as, for example, FDMA or CDMA wireless communication systems without deviating from the spirit and scope of the present invention.

In accordance with the teachings of the present invention, to be developed more fully below, one or more of subscriber units 106, 108 and communication station 114 transceiver(s) 116(A . . . N) include an innovative diversity combiner module (not shown) to implement a pre-combining technique for two or more received wireless communication signals. Those skilled in the art will appreciate from the discussion to follow that the diversity combiner module pre-combining technique is adaptive and may well be implemented in one or more of each of the communication station(s) 114 and/or subscriber unit(s) 106, 108. More particularly, the diversity combiner module disclosed herein is well suited for implementation in the communication station(s) of a TDMA-based wireless communication system, or in either/both the communication station(s) and/or subscriber unit(s) of FDMA-, TDMA- and/or CDMA-based wireless communication stations.

### Example Wireless Communication System Network Element

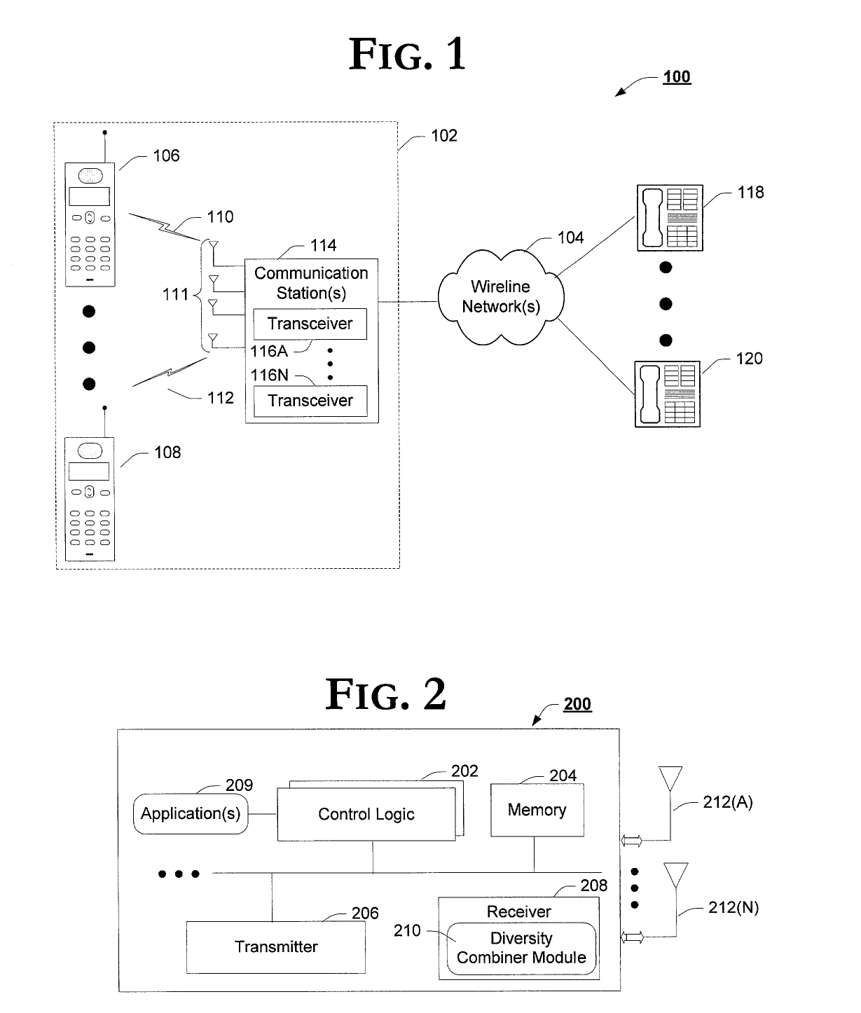

FIG. 2 illustrates a block diagram of an example wireless communication system network element incorporating the teachings of the present invention, according to one example embodiment of the present invention. In accordance with the illustrated example implementation of FIG. 2, a wireless communication system network element 200 is presented comprising control logic 202, memory 204, one or more transmitter(s) 206, one or more receiver(s) 208 at least a subset of which incorporate an innovative diversity combiner module 210, and two or more antennae 212. As used herein, communication system element 200 may well be implemented in a communication system (e.g., 102) as a subscriber unit (e.g., 106, 108), or in a communication station (e.g., 114), or as an element of one of the foregoing. Although depicted in FIG. 2 as a number of disparate blocks, one or more of the functional elements 202-212 of system element 200 may well be combined. In an alternate implementation, for example, transmitter(s) 206 and receiver(s) 208 are combined into one or more transceiver(s) (not shown). In this regard, wireless communication system network elements of greater or lesser complexity which incorporate the innovative diversity combiner module 210 are anticipated within the spirit and scope of the present invention.

As used herein, control logic 202 selectively invokes one or more application(s) 209 to control one or more of the transmitter(s) 206 and receiver(s) 208 to facilitate the wireless communication session with another network element. In this regard, control logic 202 controls certain transmit and receive characteristics to enable system element 200 to effectively communicate within the architecture of a given wireless communication system (e.g., FDMA, TDMA, CDMA, SDMA, etc.). Accordingly, except as configured in association with the teachings of the present invention, control logic 202 is intended to represent any of a number of alternate control systems known in the art including, but not limited to, a microprocessor, a programmable logic array (PLA), a micro-machine, an application specific integrated circuit (ASIC) and the like. In an alternate implementation, control logic 202 is intended to represent a series of executable instructions which, when executed by an accessing machine, implement the control logic described above.

As used herein, application(s) 209 are intended to represent a plurality of machine executable instructions and/or operational settings that may be executed by system element 200. More particularly, the instructions and operating parameters embodied within applications 209 provide the communication system element 200 with an operational “personality” when executed by, for example, control logic 202. In this regard, applications 209 may include instructions which, when executed by control logic 202, configure system element 200 to function in accordance with a TDMA-TDD standard, e.g., that of the Groupe Special Mobile (GSM) consortium.

As used herein, transmitter 206 is selectively used by control logic 202 to transmit information, e.g., conversational content, data content and the like, from element 200 to another (receiving) wireless communication system element (not shown) via a wireless communication channel. In an implementation wherein element 200 is implemented as a wireless communication subscriber unit (e.g., 106, 108), transmitter 206 establishes and maintains the uplink component of the wireless communication link in accordance with a communication standard, or personality dictated by control logic 202. In an alternate implementation wherein element 200 is utilized as a communication station (e.g., 114), transmitter 206 establishes and maintains the downlink component of the wireless communication link. In this regard, transmitter 206 is intended to represent any of a number of transmitter(s) or transmit elements of a transceiver known in the art.

Receiver 208 is selectively utilized by control logic 202 to receive information, e.g., conversational content or enhanced data services, by element 200 from another wireless communication system element via one or more antenna(e) 212 over one or more wireless communication channels and in accordance with any one or more of the wireless communication standards introduced above. Unlike conventional receivers, however, receiver 206 is depicted comprising an innovative diversity combiner module 210. Although depicted comprising diversity combiner module 210, diversity combiner module 210 may well be remotely located, yet accessible to, receiver 206 within the scope and spirit of the present invention. Thus, but for its utilization of an innovative diversity combiner module 210, receiver 206 is intended to represent any of a number of receivers or receive elements of a transceiver known in the art.

As introduced above, diversity combiner module 210 receives wireless communication signals associated with a communication session via one or more communication paths, e.g., from multiple antennae 212, modifies one or more operational characteristics of the received signals before summing such modified signals for presentation to a single receive radio element. In accordance with one aspect of the present invention, the modification of the one or more operational characteristics of the received signals is based, at least in part, on signal quality parameter(s) generated during baseband processing of previously received signals. According to one implementation, the quality parameters may include one or more of a cyclical redundancy check (CRC) error control scheme, SINR indicator(s), etc. and are derived from at least a sample of immediately previously received signal(s). In this regard, diversity combiner module 210 provides the advantages of pre-combining (i.e., only one receive radio element is required), and post-combining (i.e., more robust quality information) without assuming any specific antenna geometry, propagation channel model, etc. Indeed, in certain implementations (e.g., TDMA) to be described more fully below, diversity combiner module 210 also provide active interferer nulling in addition of signal to noise ratio (SNR) gain and fading protection.

Again, for ease of illustration and explanation, diversity combiner module 210 is presented as a functional module of system element 200. Those skilled in the art will appreciate, however, that diversity combiner module 210 need not be co-located with, for example, the radio elements (e.g., transmitter/receiver elements) of the wireless communication system and yet interact with such radio elements (e.g., 106, 108 and/or 114) to implement the teachings of the present invention.

### Example Diversity Combiner Module Architecture and Implementation

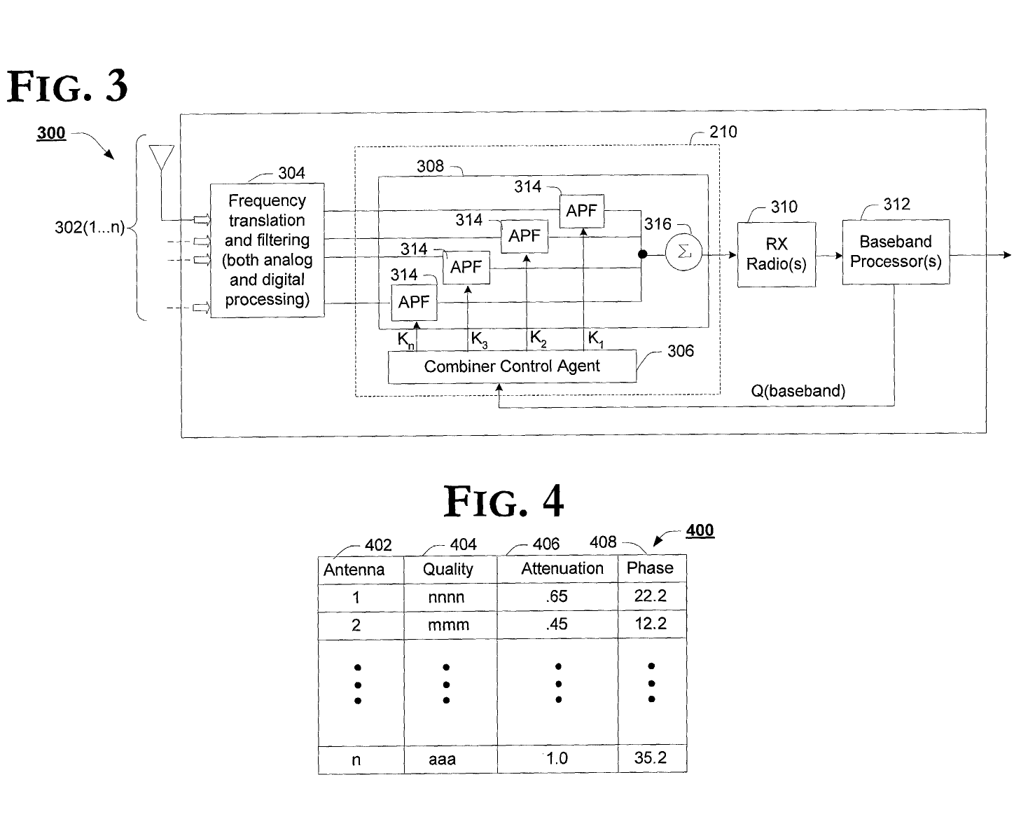

FIG. 3 illustrates a block diagram of an example receiver 300 incorporating the teachings of the present invention, in accordance with but one implementation of the present invention. As used herein, receiver 300 may well be implemented in one or more of subscriber unit(s) 106, 108 and/or communication station transceiver(s) 116. In accordance with the illustrated example embodiment of FIG. 3, receiver 300 is presented comprising frequency translation and filtering stage(s) 302 coupled to the innovative diversity combiner module 210, a receive radio 310 and one or more baseband processor(s) 312, each coupled as depicted. In accordance with one example implementation of the present invention, diversity combiner module 210 is presented comprising a combiner control agent 306, a diversity combiner 308 including all-pass filter element(s) 314 and a summing node 316, each coupled as depicted to selectively modify one or more characteristics of the received signals before combining such signals for presentation to receive radio 310.

But for incorporating the teachings of the present invention, receiver 300 is intended to represent any of a number of receiver architectures known in the art. In this regard, frequency translation and filtering module 302 receives the RF signal from the antenna(e), filters identified noise, and may perform some initial amplification for presentation to diversity combiner module 210. As will be discussed more fully below, diversity combiner module 210 selectively modifies one or more operational characteristics of select ones of the one or more received communication signals, in accordance with control parameters generated by combiner control agent 306, before generating a composite of such signals for presentation to the receive radio. Receive radio 310 receives the operationally enhanced, composite signal from diversity combiner 210, downconverts the signal to an intermediate frequency (IF), filters the downconverted signal to reduce noise elements, and digitizes the IF signal for conversion to baseband. The filtered, IF signals are then presented to baseband processor(s) 312 for conversion to baseband.

According to one example implementation, baseband processor(s) 312 convert the IF signal to baseband and demodulate the received signal for use by wireless communication system element. In the process of downconversion and demodulation of the baseband signal, baseband processors 312 generate quality measure(s) of the received signal for use by receiver 300. According to one aspect of the present invention, such quality measure(s) are presented to combiner control agent 306 for use in generating one or more combiner control parameters (K). In this regard, according to the normal operation of such baseband processor(s) 312, quality information such as CRC value(s), SINR measures, or any other quality measure typically generated by such baseband processor(s) are presented to combiner control agent 306 on substantially a real-time basis.

In accordance with the illustrated example implementation, diversity combiner module 210 is presented generally comprising a combiner control agent 306 coupled to a diversity combiner 308. The diversity combiner 308 receives RF signal(s) from one or more antennae 302(1 . . . n) via the frequency translation and filtering module 304, and selectively modifies one or more operational characteristics of one or more of the received signals on an individual basis, according to one or more control parameters received from combiner control agent 306.

Combiner control agent 306 receives signal quality information from, e.g., one or more of frequency translation and filtering module 304 and or baseband processor(s) 312, and dynamically generates a control parameter (Kₙ) for one or more of the received signals to control one or more operational attributes of the associated one or more received signals. According to one implementation, for example, combiner control agent 306 generates a control parameter (Kₙ) utilized by combiner 308 to control an amplitude (Aₙ) and/or the phase (φₙ) of an associated received signal. In this regard, amplitude is controlled by selective attenuation of the signals, while phase control improves the deltaPhi (phase difference, or spatial diversity) of the received signal(s). According to one implementation, combiner control agent 306 utilizes one or more RF signal characteristics (e.g., RSSI) and/or one or more baseband quality characteristics (e.g., SINR, CRC figures, etc.) to generate the control parameter Kn for each of the received signals. In accordance with the teachings of the present invention, the RF signal characteristics are merely used by control agent 306 during the initial processing of the received signals. Once a sample of baseband quality figures are available from one or more of the baseband processors 312, control agent 306 relies heavily on such information to generate the control parameter for each of the receive paths.

The control parameter (Kn) is generally defined mathematically as:

Kₙ=Aₙe^{(jφ(n)r(n))} (1)

where: An is an attenuation value; and

φn is a phase shift.

According to one implementation of control agent 306, when A1 is set equal to one (1) (or, no attenuation), A2 is equal to or less than one (1); alternatively, when A2 is set equal to one (1), A1 is less than or equal to one. In alternate implementations, both A1 and A2 can be a fixed unit (e.g., a hardware implementation wherein A1 and A2 are not dynamically controllable) in which the performance of combiner 210 will be slightly reduced. Phi1 and Phi2 (φ1 and φ2) are the phase shift on each signal branch, since th relatively phase shift (deltaPhi) is the figure of interest, control agent 306 selectively modifies φ1 and φ2 to provide improved receive performance. Careful selection of the attenuation and, more importantly, the deltaPhi is useful to improve SNR (i.e., by up to 3 dB or 2X in the case of a 2 antenna system, while improving fading and Signal to Interferer Ratio (SIR) figures.

Accordingly, the output of the diversity combiner 308 may well be represented as:

R=A₁e^{(jφ(1))r(1))}+A₂e^{(jφ(2)r(2))}+. . . Aₙe^{(jφ(n)r(n))} (n)r(n)) (2)

where: 1, 2 . . . n denote the particular communication path.

It is the operationally enhanced composite signal (R), defined above, that is presented to receive radio 310, where it is amplified and downconverted to baseband and processed by baseband processor(s) 312, as described above.

As the overall quality of the composite signal (R) can be represented by the signal to interference and noise ratio (SINR), it is sufficient for the control agent 306 to modify one or more of the elements of the control parameter K to increase the SINR observed in (R) at the baseband processor(s) 312. Thus, according to one implementation, control agent 306 manages such control parameter elements in accordance with the following gradient-style algorithm:

Δφ(n+1)=Δφ(n)+dφ(n); (3)

where SINR is measured at time (n+1), and perform the following:

ΔSINR(n+1)=SINR(n+1)−SINR(n); (4)

dφ(n+1)=g(ΔSINR(n+1)*dφ(n); (5)

where g is some monotonic increasing function which holds:

g(x)<0 if x<0,

and

g(x)>0 if x>0.

This function employed by control agent 306 can be optimized for both convergence speed and tracking capabilities of the receiver. Function (g) can also be dependent on a rate of change parameter which characterize the speed of change of the propagation channel. Those skilled in the art will appreciate that this may well be an estimate of the speed of the subscriber unit. This type of adaptive gradient approach implemented by control agent 306 can also be used for converging on the attentuation ratio A2(n)/A1(n). Alternatively, the attenuation may well be derived from a relative signal strength measurement done directly on the received signals, which is also well suited when trying to form weighting values for an implementation using Maximum Ratio Combining (MRC).

According to one example implementation, the diversity combiner 308 is comprised of all-pass filters (APF) 314 with dynamically controllable, linear phase characteristics. According to one implementation, the linear phase slope of the APF 314 is controlled using a voltage controlled capacitor or inductor (not shown) responsive to one or more aspects of the control parameter (K) generated by combiner control agent 306. According to one implementation, APF 314 are dynamically controllable to modify one or more of the amplitude (Aₙ) and/or phase (φₙ) of any of the received signals according to the received control parameter (Kₙ) associated with a given received signal.

Summing module 316 selectively combines the signals to generate a spatial composite of the received signals, utilizing the energy of each of the received signals in an effort to improve the signal to noise ratio (SNR) of the received signal.

### Example Data Structure

Turning to FIG. 4 an example data structure comprising historical performance information is presented, according to one example implementation of the present invention. According to one implementation, data structure 400 includes historical quality information received from, for example baseband processor(s) 312. In accordance with one implementation, data structure 400 may well include RF quality measures on a per-signal path (associated with each antenna) basis. As used herein, data structure 400 is integrated within combiner control agent 306. In alternate implementations, however, data structure 400 may well reside external to control agent 312, such as in memory 204, for example.

In accordance with the illustrated example implementation of FIG. 4, data structure 400 is presented comprising antenna identifier field 402, quality measure field(s) 404, an associated attenuation and phase field(s) 406 and 408 respectively. In this regard, control agent 306 maintains a history of quality values and associated attenuation and deltaPhi values for use in one or more of the gradient equations above. It should be appreciated that data structures of greater or lesser complexity may well be used in accordance with the teachings of the present invention without deviating from the scope or spirit of the present invention.

### Example Operation and Implementation

Having introduced the functional and architectural elements of the present invention with reference to FIGS. 1 through 4, an example operation and implementation will be further developed with reference to FIG. 5. For ease of illustration, the operational detail of the present invention will be developed with continued reference to FIGS. 1-4.

FIG. 5 is a flow chart of an example method of implementing a pre-combining diversity scheme within a communication system element in accordance with the teachings of the present invention. In accordance with the illustrated example embodiment of FIG. 5, the method begins with block 502 wherein a wireless communication system element 200 receives one or more wireless communication signals through one or more wireless communication paths. In accordance with one embodiment, the one or more communication paths include signals associated with a single communication session received via multiple antennae 212.

In block 504, the received signals are passed to diversity combiner module 210, which selectively modifies one or more operational characteristics of one or more of the received signals based, at least in part, on available quality indicator(s). As introduced above, the signals are passed to diversity combiner 308 where one or more operational characteristics of the received signals, e.g., the amplitude or relative phase of the signals, using dynamically controllable all-pass filters with linear phase characteristics. According to one implementation, introduced above, combiner control agent 306 dynamically generates a control parameter (K) for each of the signals based, at least in part, on available quality information such as, for example, RSSI information, CRC-figures and/or SINR values. Such modified signals are selectively combined to generate an operationally enhanced composite signal (R), as defined above.

In block 506, the operationally enhanced composite signal is passed to receive radio 310, for downconversion to baseband for baseband processor(s) 312 until call-tear down.

In block 508, during facilitation of the call, control agent 306 continues to receive one or more quality indicator(s) from at least the baseband processors. As introduced above, RF quality indicators may also be received, e.g., from frequency translation and filtering module 304.

If, in block 510, control agent 306 determines that the received quality measures continue to meet or exceed a threshold which indicates an acceptable signal quality, control agent 306 maintains the current control parameter (K) used by diversity combiner 308 to modify one or more operational characteristics of the received signals using the current modification parameters (e.g., A and φ).

If, however, control agent 306 determines that the received quality measures do not meet an acceptable threshold, block 510, control agent selectively modifies one or more modification parameters (A, φ), as described above, until convergence on an acceptable set of operational attributes is achieved, as measured against the quality threshold.

### Alternate Embodiments

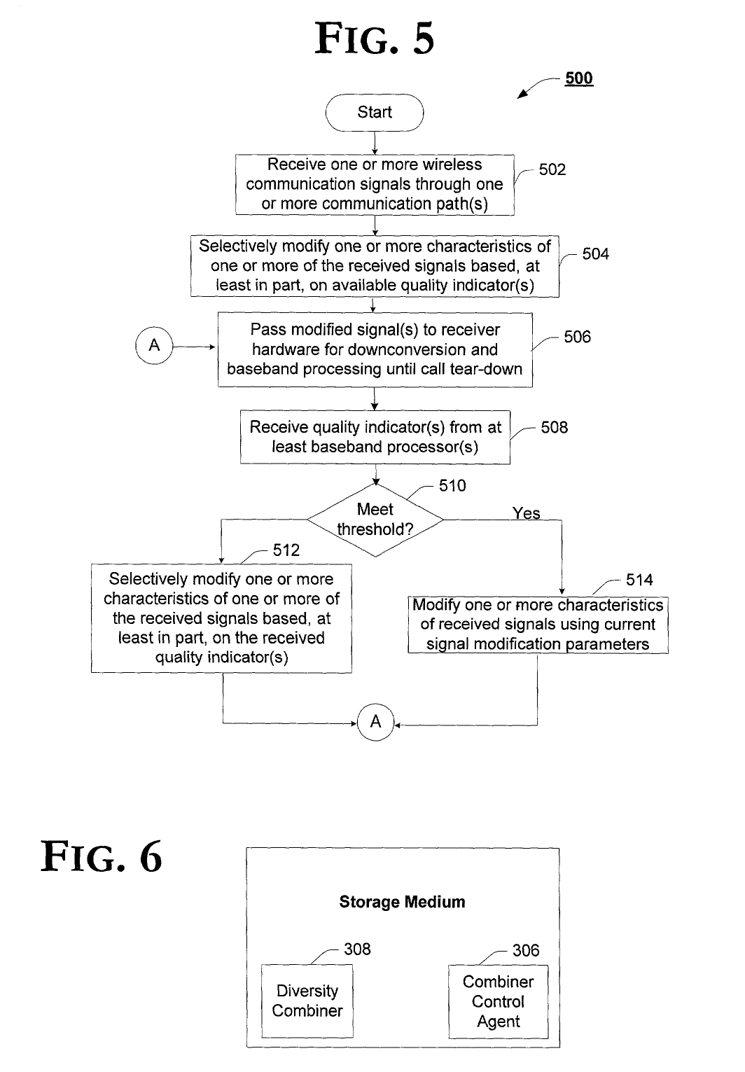

FIG. 6 is a block diagram of a storage medium having stored thereon a plurality of instructions including instructions to implement one or more of elements of the diversity combiner module 210. More particularly, according to one implementation, storage medium 600 includes instructions which, when executed, implement a combiner control agent 306 and/or a diversity combiner 308, as developed above.

As used herein, storage medium 600 is intended to represent any of a number of storage devices and/or storage media known to those skilled in the art such as, for example, volatile memory devices, non-volatile memory devices, magnetic storage media, optical storage media, and the like. Similarly, the executable instructions are intended to reflect any of a number of software languages known in the art such as, for example, C++, Visual Basic, Hypertext Markup Language (HTML), Java, extensible Markup Language (XML), and the like. Moreover, it is to be appreciated that the storage medium/device 600 need not be co-located with any host system. That is, storage medium/device 600 may well reside within a remote server communicatively coupled to and accessible by an executing system. Accordingly, the software implementation of FIG. 6 is to be regarded as illustrative, as alternate storage media and software embodiments are anticipated within the spirit and scope of the present invention.

Although the invention has been described in the detailed description as well as in the Abstract in language specific to structural features and/or methodological steps, it is to be understood that the invention defined in the appended claims is not necessarily limited to the specific features or steps described. Rather, the specific features and steps are merely disclosed as exemplary forms of implementing the claimed invention. It will, however, be evident that various modifications and changes may be made thereto without departing from the broader spirit and scope of the present invention. The present specification and figures are accordingly to be regarded as illustrative rather than restrictive. The description and abstract are not intended to be exhaustive or to limit the present invention to the precise forms disclosed.

The terms used in the following claims should not be construed to limit the invention to the specific embodiments disclosed in the specification. Rather, the scope of the invention is to be determined entirely by the following claims, which are to be construed in accordance with the established doctrines of claim interpretation.

In accordance with the teachings above, we claim the following:

1. An apparatus comprising:
a diversity combiner, to selectively modify each of two or more received wireless communication signals and generate a composite signal from at least a subset of the modified received signals; and
a combiner control agent, coupled to the combiner, to dynamically generate a control parameter for each of the received signals to control combiner modification of the signals in generating the composite signal based, at least in part, on one or more quality values generated during baseband processing of prior composite signal(s).

2. An apparatus according to claim 1, wherein the control parameters include one or more of an attenuation value and/or a phase-shift value for each of the received signals.

3. An apparatus according to claim 1, wherein the combiner is comprised of a passive all-pass filter with linear phase characteristics for each of the received signals, wherein a linear phase slope of each of the filters is independently controlled by a received control parameter.

4. An apparatus according to claim 1, wherein the combiner controller receives quality values from at least a baseband processor.

5. An apparatus according to claim 4, wherein the quality values received from the baseband processor include one or more of a signal to interference and noise ratio (SINR) value, a cyclical redundancy check (CRC) figure, and the like derived from a demodulated representation of the composite signal.

6. An apparatus according to claim 1, wherein the combiner control agent receives radio frequency quality value(s) associated with one or more of the received signals.

7. An apparatus according to claim 6, wherein the radio frequency quality values include a received signal strength indication (RSSI).

8. An apparatus according to claim 1, wherein the combiner control agent generates a control parameter (K) which, when interpreted by elements of the combiner, selectively control one or more of an attenuation value (A) and a relative phase value (φ) of a received signal.

9. An apparatus according to claim 8, wherein the combiner control agent generates a control parameter (K) in accordance with Kₙ=Aₙe^{(jφ(n)r(n))} for at least a subset of n received signals.

10. An apparatus according to claim 1, wherein one or more of an attenuation value (A) and a phase value (φ) associated with at least a subset of the received signals are selectively modified in response to a control parameter (K) associated with such subset of signals received from the combiner control agent to generate the composite signal (R) according to R=A₁e^{(jφ(1)r(1))}+A₂e^{(jφ(2)r(2))}+Aₙe^{(jφ(n)r(n))}.
